(19) United States
(12) Patent Application Publication
(10) Pub. No.: US 2007/0035134 A1
(43) Pub. Date: Feb. 15, 2007

(54) System for generating electrical energy

(76) Inventor: Theodore R. Bristow JR., Kailua-Kona, HI (US)

Correspondence Address: THEODORE J. BIELEN JR., 1390 WILLOW PASS ROAD, SUITE 1020, CONCORD, CA, 94520, US

(21) Appl. No.: 11/503,252

(22) Filed: Aug. 11, 2006

Related U.S. Application Data
(60) Provisional application No. 60/707,563, filed on Aug. 12, 2005.

(51) Int. Cl. H02K 7/18; F03G 7/08; F02B 63/04

(52) U.S. Cl. 290/1 R

(57) ABSTRACT

A system for generating electrical energy utilizing one or more of electrical generators. A linking member is connected to the actuating shaft(s) of the generator(s) and a mobile member contacts the frictional surface of the linking member to rotate the same. In turn, the shaft(s) of the generator(s) are rotated to produce electrical power.

### CROSS-REFERENCES TO RELATED APPLICATIONS

The present application is based on provisional application No. 60/707,563 filed 12 Aug. 2005 and claims the priority date of that application.

### BACKGROUND OF THE INVENTION

The efficient generation of electrical power is always a sought after objective when designing electrical systems.

Along these lines, recent developments of lamps have included the prominence of the light emitting diode (LED). LEDs have been adapted for many uses including reading lights, pool illumination, traffic lights, to name a few. It has been estimated that the light output per watt of a typical LED is six times that of the conventional incandescent light bulb. Also, the LED lamp has been measured as being more efficient than a fluorescent light bulb. Moreover, LED circuits require only small gauge wire and may be illuminated anywhere an electrical connection is made over a long distance of wire.

Generation of electricity to power energy efficient lights and the like have been a major concern in the electrical industry. For example, U.S. Pat. No. 6,989,807 describes and LED driving device utilizing a plurality of LEDs and a current switching circuit to automatically activate a plurality of LEDs in the greatest number.

U.S. Pat. No. 5,430,626 shows an illuminated display construction in which lamps are employed in a device in a segmented fashion to form an illuminated object such as a five pointed star.

U.S. Pat. No. 6,988,816 utilizes a lighting apparatus having a reflective system which projects uniform illumination by spacing a light source within the reflector system such that the geometric center of the light source is spaced outwardly from the optical center of the housing.

U.S. Pat. No. 6,346,777 describes an LED lamp apparatus in which the lamps are arranged in series or parallel to form a block which also includes the driver and control circuits for the LED lamps. An epoxy resin encompasses the block to form a case.

U.S. Pat. No. 6,988,812 describes a lighting apparatus in which a light source is disposed in a hollow module and the light is dispersed using a rectangular lens. The light is projected onto a display surface for use.

A system for generating electrical energy for use with electrical loads such as lighting systems in an efficient manner would be a notable advance in the electrical field.

### BRIEF SUMMARY OF THE INVENTION

In accordance with the present invention a novel and useful system for generating electrical energy is herein provided.

The system of the present invention utilizes a first electrical generator having a first rotatable actuating shaft. A second electrical generator may also be included with a rotatable actuating shaft and is placed adjacent to the first electrical generator. A linking member connects to the first and second rotatable actuating shafts of the first and second generators and includes a frictional surface. A mobile member contacts the friction surface of the linking member to rotate the first and second actuating shafts. The mobile member may move in a rectilinear direction or in an arcuate path. The mobile member may be formed as part of a bicycle tire, auto tire, and the like. In any case, the output of the generators may be harnessed to illuminate LEDs, to turn a fan, to pump water, and the like.

The generators of the present invention may take the form of stepper motors used alternators or dynamos. In certain cases, the stepper motors may have multiple steps which would result in the generation of electrical current having a high frequency. Normally, the higher number of steps of the stepping motor produces a higher frequency a lower speed of the stepper motor. Thus, less load is placed on the stepper motor during generation of electrical current. Also, a stepper motor having a high detent torque would result in the production of a higher current and a higher load from such motor than motors having a lower detent torque.

The power from the stepper motor, prior to being fed to a load such as an LED, may be fed to capacitors, in parallel or in series such as super capacitors, which may be used in parallel to form a storage cell. LEDs also act as rectifiers and, thus, efficiently charge super capacitors electrically linked to the same. When wired in series, super-capacitors serve as a storage “bank”, which may power more than the initial loads placed on the output of the dynamo. A battery, or a bank of LEDs, may also be connected to the capacitor storage cell. In certain cases the battery may also be fed back to a motor which runs the stepper motor used as a dynamo. In other words, the mobile member of the generating system may take the form of the output shaft of a DC motor and the like. In certain instances a solid state circuit would control the switching of the circuit from the dynamo to alternately charge the super capacitors. For example, a 400 stepper motor reaches a harmonic resonance and produces an output current of between 144 kilocycles to 288 kilocycles. Such high frequency electrical current generated by the stepper motor/dynamos successfully drives LEDs as the load and/or is capable of charging capacitors as a storage cell.

LED clusters may also be employed and may include LEDs of various colors to produce a light output of a desired intensity and hue.

Solar panels may also be employed with the present invention to produce electrical power to the mobile member, be it one moving in a rectilinear motion or in a rotary motion, which in turn rotates the actuating shafts of the first and second electrical generators. In certain cases, the solar source may be directly fed to the battery when a battery is used in conjunction with the capacitor cell receiving the output from the generation system heretofore described.

It should be noted, that the electrical output from the stepper motor dynamos could also be used to operate fans, pump water in an irrigation system, to power an automobile electrical system, to illuminate fluorescent lights, to illuminate traffic lights, and the like.

It may be apparent that a novel and useful system for generating electrical energy has been hereinabove described.

It is therefore an object of the present invention to provide and electrical generating system which employs stepper motors used as alternators or dynamos that may be operated with a mobile member moving in an rectilinear or rotary direction.

Another object of the present invention is to provide a system for generating electrical energy using at least pair of stepper motors acting as a dynamo in which the mobile member turning the actuating shafts of the stepper motors receives its energy from a pendulum or a rotating wheel.

A further object of the present invention is to provide an electrical generating system in which electrical power derived therefrom is at a high frequency and is capable of driving one or a plurality of LEDs formed in a cluster.

Another object of the present invention is to provide a system for generating electrical energy which may be employed with stepper motors used as dynamos and in conjunction with a solar collector to motivate a mobile member used in conjunction with the dynamos.

A further object of the present invention is to provide an electrical generating system which is capable of illuminating LEDs of various colors to produce a composite projection of light of a certain hue which is capable of acting as grow light.

Another object of the present invention is to provide a system for generating electrical energy which may be used to operate ventilation equipment.

A further object of the present invention is to provide a system for generating electrical energy which may be employed to operate irrigation equipment, including water pumps.

Another object of the present invention is to provide an electrical generating system which may be used in conjunction with a hydraulic fluid to operate a mobile member to be used in conjunction with stepper motors operated as dynamos or alternators.

The invention possesses other objects and advantages especially as concerns to particular characteristics and features thereof which will become apparent as the specification continues.

### BRIEF DESCRIPTION OF THE SEVERAL VIEWS OF THE DRAWING

FIG. 1 is a sectional view of an embodiment of the invention using a quartet of stepper motors.

FIG. 2 is a sectional view taken along line 2-2 of FIG. 1.

FIG. 3 is a side elevational view of a portion of a device illustrating the use of a pendulum to operate a plurality of dynamos used in conjunction with the present invention.

FIG. 4 is a schematic view detailing the operation of the pendulum of FIG. 3.

FIG. 5 is a schematic view of a portion of the system of the present invention in which multiple clusters of LEDs are illuminated.

FIG. 6 is a schematic view of the present invention utilizing a fly wheel and a solar collector in conjunction with a motor to operate a pair of dynamos of the present invention.

FIG. 7 is a schematic view indicating the generation of electrical power from a dynamo employed in the present invention and a plurality of super capacitors in parallel serving as a storage cell.

FIG. 8 is a schematic view of a system used in conjunction with a dynamo generator of the present invention in conjunction with a solid state switch linked to a multiplicity of LEDs.

FIG. 9 is a schematic view indicating multiple uses for the electrical energy generated by the dynamo system of the present invention.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

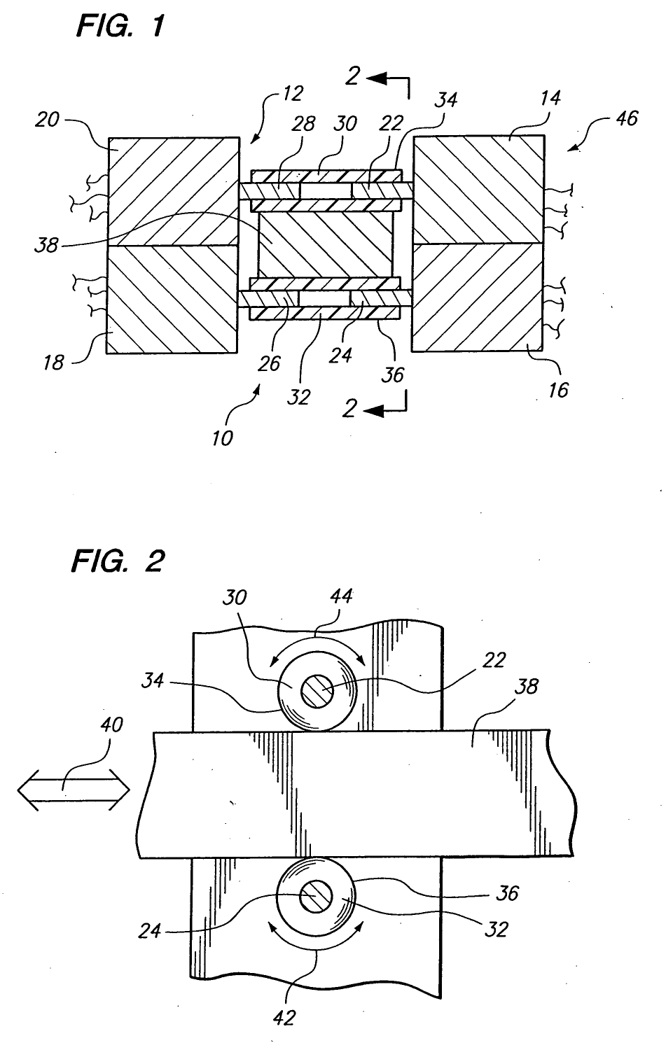

With reference to FIG. 1, it may be observed that an embodiment the invention is shown as a whole therein by reference character 10. Electrical generating system 10 includes as one of its elements a plurality of electrical generators 12. FIG. 1 depicts generators 14, 16, 18, and 20, in this regard. Dynamos 14, 16, 18, and 20 include rotatable actuating shafts 22, 24, 26, and 28, respectively. It should be noted that dynamos 14, 16, 18, and 20 may be mounted on a suitable support or frame (not shown) of conventional configuration. Each stepper motor employed in the present invention may be of the bipolar type, 0.9° per step with a 12 ohm rating. In addition the motor may include 16 coils wired into two phases to increase the voltage output. The negative outputs of both phases are preferablly combined to serve as a center tap relative to the positive output phases. Although such stepper motor includes conventional mechanical rotor pairs, such rotor pairs may be altered to eliminate the half step offset typically found in such a stepper motor. The addition of an inductor of the negative output of such altered stepper motor/dynamo will again permit the positive and negative output to pulse together. Dynamos 16, 18, 20, and 22 produce an alternating current having a frequency of, typically, 144 kilohertz to 288 kilohertz.

A linking members are also connected to pairs of dynamos. For example, dynamos 14 and 20 include a linking member 30 while dynamo 16 and 18 are used in conjunction with linking member 32. Linking members 30 and 32 may take the form of an elastomeric tubular material. Frictional surfaces 34 and 36 are associated with linking members 30 and 32 respectively, FIGS. 1 and 2.

A mobile member 38 travels between linking members 30 and 32 according to directional arrow 40, FIG. 2. Mobile member 38 engages frictional surfaces 34 and 36 of linking members 30 and 32, respectively, and turns the same according to directional arrows 42 and 44. Linking member 30 and 32 snugly fit around actuating shafts 22, 24, 26, and 28 of dynamos 14, 16, 18, and 20. Thus, shafts 22, 24, 26, and 28 turn according to directional arrows 42, and 44, depicted with respect to shafts 22 and 24 on FIG. 2. Consequently, electrical current is generated by dynamos 14, 16, 18, and 20 which conducted through plurality of wires 46, FIG. 1.

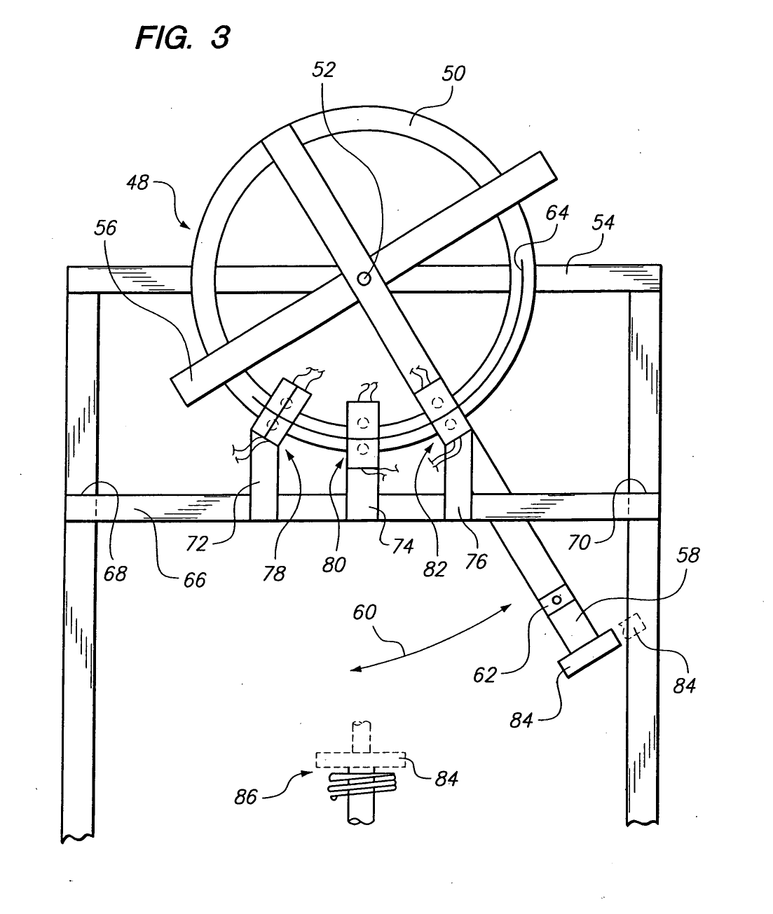

Turning to FIG. 3, it may be seen that a pendulum apparatus 48 is depicted. Pendulum apparatus 48 includes a wheel 50 which rotates about axis 52 held to frame 54. it should be noted that frame 54 is shown partially in FIG. 3 and may be constructed in a conventional manner to be supported on a ground surface or mounted to a vertical surface, as desired. Cross bar 56 supports pendulum arm 58 and permits the rotation of the same according to directional arrow 60. Adjustable weight 62 is employed along arm 58 to balance its swinging motion. It should be noted that a plurality of weights, such as weight 62, may be used along pendulum arm 58. Wheel 50 also supports mobile member 64 which is depicted as an arcuate strip. However, mobile member 64 may be formed of any desirable thickness. Support bar 66 is extended outwardly from the remainder of frame 54 by cantilevered members 68 and 70. Supports 72, 74, and 76 are fixed to cross bar 66 and support pairs of dynamos 78, 80, and 82. Pairs of dynamos 78, 80, and 82 include actuating shafts and linking members similar to that shown in FIG. 1 to allow contact with mobile member 64, in the same manner with respect to mobile member 38 of FIGS. 1 and 2. Thus, electrical current is generated in pairs of dynamos 78, 80, and 82 during every swing of pendulum arm 58.

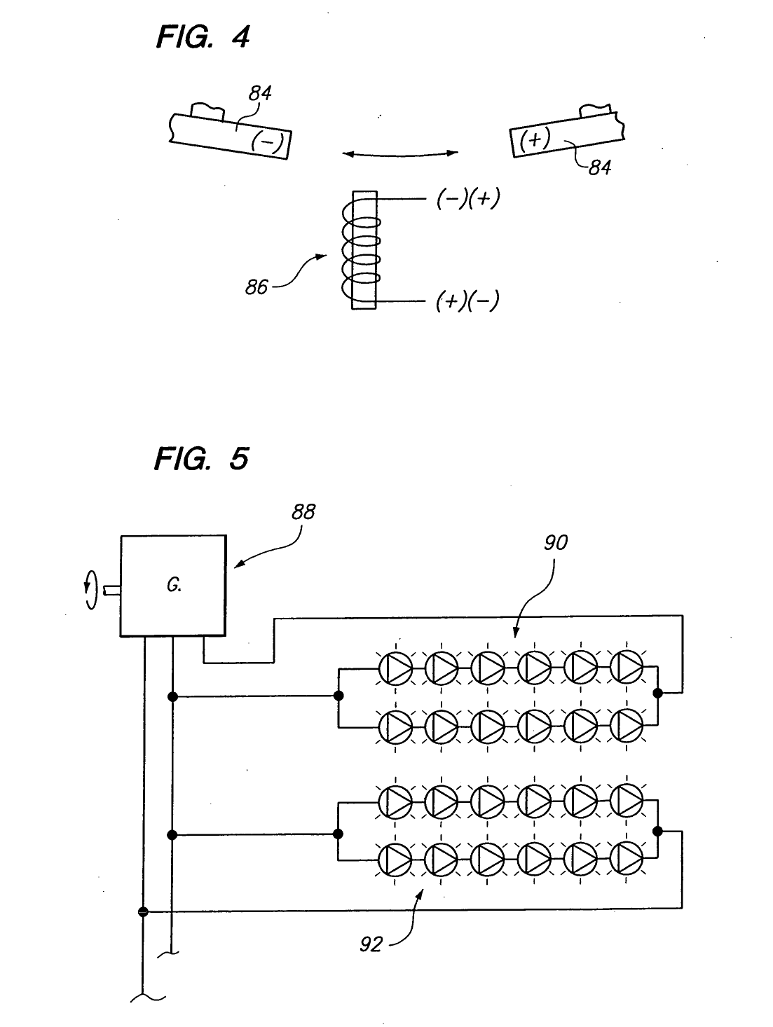

A permanent magnet 84, located on the end of pendulum arm 58 interacts magnetically with permanent magnet 86 during each swing of pendulum art 58. FIG. 4 illustrates that permanent magnet 86 may include a charge on its pole nearest permanent magnet 84 which is either opposite to or the same as polarity of permanent magnet 84. The polarity of electromagnet 86 is alternated by a switching mechanism of conventional configuration. Thus, permanent magnet 84 is attracted to electromagnet 86 on its swing toward electromagnet 86 and repelled from electromagnet 86 when it is moving away from the same. Of course, other means may be employed to move pendulum arm 58 such as a motor, spring mechanism, and the like.

Viewing now FIG. 5, once electrical current is generated by system 10 through one or more dynamos, such as 88, power may be employed to illuminate lamps such as arrays or banks of LEDs 90 and 92. LEDs arrays 90 and 92 may be of various colors such as red, green, white and the like. The combination of such colors may be chosen to produce a specific hue for illumination of a space, to produce a desired aesthetic affect, and the like. Plurality of LED arrays may be connected in series or parallel in a conventional manner. Banks 90 and 92 may be alternately switched and individually controlled with respect to intensity, for example by a pulse width modulator.

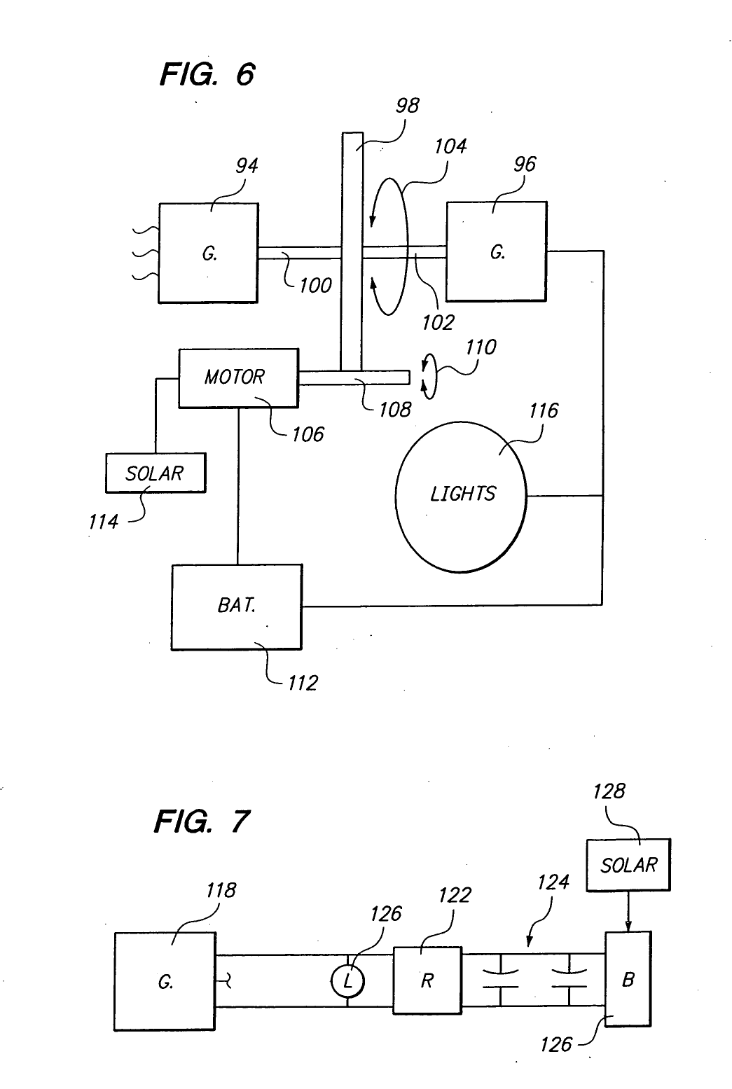

Referring to FIG. 6, it may be seen that the system 10 of the present invention may be employed in other environments. For example, dynamos 94, and 96 may be employed with a fly wheel 98 connected to actuating shafts 100 and 102 of dynamos 94, and 96. It should be noted that fly wheel 98 and actuating shafts 100 and 102 may turn in either direction according to directional arrow 104. Fly wheel 98 may be rotated by motor 106 via shaft 108 according to directional arrow 110. Motor 106 may receive its electrical power from battery 112 and/or solar collector 114. Motor 106 may take the form of a windmill or a fan rotating by dint of attachment to a moving vehicle such as a car, scooter, bicycle, or the like. Also, motor 106 may take the form of a water operated turbine connected to the water feed of a sprinkler system. The electrical energy from dynamos 94 and 96 may be employed to illuminate landscaping lighting, preferably composed of LEDs. Like wise, motor 106 may be gas operated, receiving a gaseous flow from the exhaust of a vehicle or other combusting engine. In addition, generator 9 and/or 96 may be miniaturized to obtain rotational energy from a vehicle wheel. In the case of a bicycle wheel, this result is achieved by a conventional spring-loaded roller pinch wheel linked to a spindle generator. Moreover, a fan may be employed as motor 106 via a conventional mechanical linkage. Such fan may take the form of a ceiling fan. The output of dynamos 94, and 96 may be employed to illuminate lights 116, which may be LEDs, incandescent lamps, fluorescent lamps, high intensity discharge lamps, and the like. It should be noted that although only the output of dynamo 96 is depicted in FIG. 6 and it should be understood that the same load may be applied to dynamo 94 therein. It should also be realized that energy from either dynamo 94 or dynamo 96 may be passed to battery 112 to aid in the operation of motor 106.

FIG. 7 illustrates schematically the generation of electrical power from dynamo or generator 118. Again, the electrical power produced by dynamo 118 through system 10 of the present invention is capable of illuminating a light or lights 120. Rectifier 122 is also employed to send DC power to storage bank 124 which may be in the form of a capacitor or capacitors. Preferably, storage bank 124 are a multiplicity of super capacitors, in series or in parallel which allows a slow charging of battery 126. Capacities found in storage bank 124 may be charged in sequence to achieve this affect. In addition, solar collector 128 may be employed to charge battery 126. It should be realized that solar collectors 114, FIG. 6, and 128, FIG. 7 may receive photon emissions from LEDs 116 and 120, respectively, in certain cases.

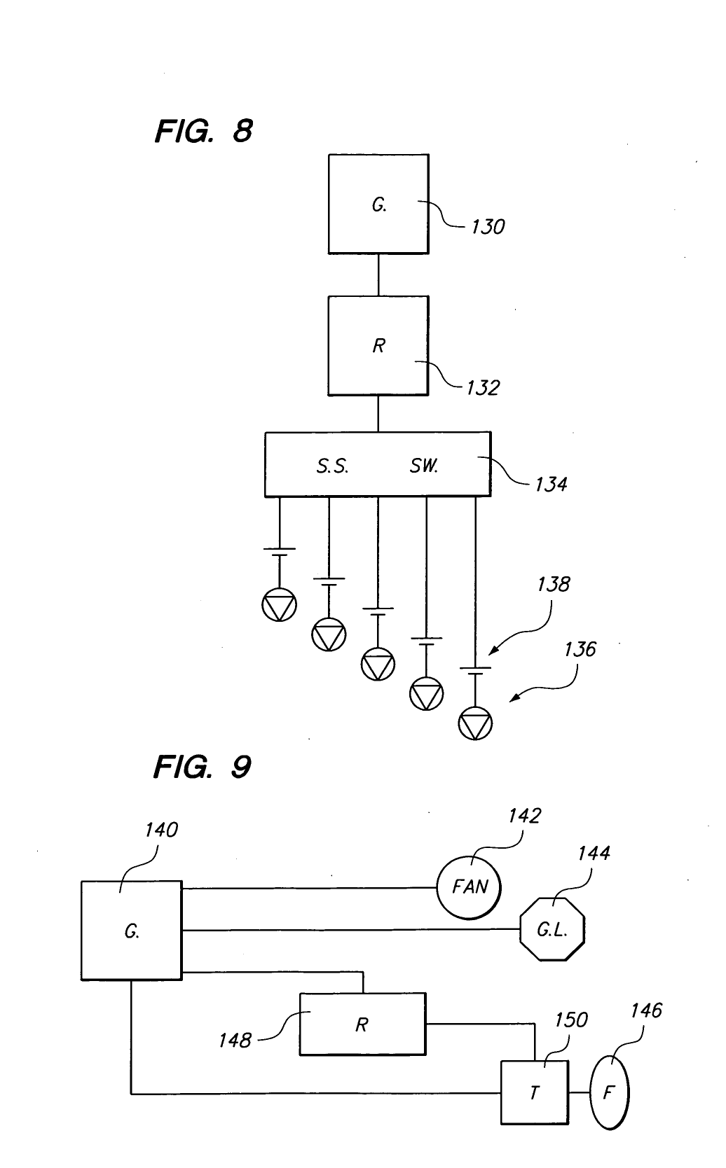

Turning to FIG. 8, it may be observed that another system using generator system 10 of the present invention for the production of electrical energy from dynamo 130, which is passed through bridge rectifier 132. Solid state switching mechanism 134 alternately passes electrical energy to plurality of LEDs 136 which are fed such electrical energy via plurality of capacitors 138.

FIG. 9 generally illustrates the use of dynamo 140 of the system 10 of the present invention which may be employed to operate a fan 142, illuminate grow lights 144 or operate fluorescent light(s) 146 via rectifier 148 and transformer 150. In the latter case electrical energy to transformer 150 may be drawn from the center tap of dynamo 140, as alternating current, as well as direct current from rectifier 148. It has been found that this arrangement increases the output of the fluorescent light(s) 146.

In operation, system 10 generates electrical energy by the use of stepper motors such as stepper motors 16, 16, 18, and 20 by rotating operating shafts 22, 24, 26, and 28, respectively through linking members 30 and 32. Mobile member 38 may move linearly or arcuately, or circularly in contact with linking members 30 and 32 to generate electrical current. The system of the present invention may be employed in conjunction with fly wheel 98 operated by motor 106 which is run through a battery or a solar collector. The electrical energy may be used to power LEDs, electric lights, fans, pumps for irrigation, and the like as desired.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A system for generating electrical energy comprising:
a. a first electrical generator having a first rotatable actuating shaft;
b. a second electrical generator having a second rotatable actuating shaft;
c. one linking member connected to said first and second rotatable actuating shaft, said one linking member having a frictional surface;
d. a mobile member, said mobile member contacting said frictional surface of said one linking member and rotating said first and second rotatable actuating shafts to generate and electrical output;

2. The system of claim 1 in which said one liming member comprises a hollow member, said hollow member at least partially surrounding said first and second rotatable actuating shafts.

3. The system of claim 1 in which said electrical output of said first and second electrical generators are linked to a multiplicity of light emitting diodes to illuminate said multiplicity of light emitting diodes.

4. The system of claim 1 in which said electrical output of said first and second electrical generators are linked to a battery.

5. The system of claim 4 in which said battery includes an isolating capacitor.

6. The system of claim 1 which additionally comprises:
a. a pendulum, said mobile member being connected to said pendulum;
b. a permanent magnet fixed to the arm of said pendulum; and
c. an electromagnet receiving electrical energy, said electromagnet positioned in the vicinity of said permanent magnet;
d. a switch for controlling the flow of said electrical energy to said electromagnet.

7. The system of claim 1 which additionally further comprises:
a. a third electrical generator having a third rotatable actuating shaft;
b. a fourth electrical generator having a fourth rotatable actuating shaft; and
c. another linking member connected to said third and fourth rotatable actuating shafts, said another linking member having a frictional surface;
said mobile member additionally contacting said frictional surface of said another linking member and rotating said third and fourth rotatable actuating shafts to generate an electrical output.

8. The system of claim 7 in which said another liking member comprises a hollow member, said hollow member at least partially surrounding said third and fourth rotatable actuating shafts.

9. The system of claim 7 in which said electrical output of said first, second, third and fourth electrical generators are linked to multiplicity of light emitting diodes to illuminate said multiplicity of light emitting diodes.

10. The system of claim 7 in which said electrical output of said first, second, third and fourth electrical generators are linked to a battery.

11. The system of claim 10 in which said battery includes an isolating capacitor.

12. The system of claim 7 which additionally comprises:
a. a pendulum, said mobile member being connected to said pendulum;
b. a permanent magnet fixed to the arm of said pendulum; and
c. an electromagnet receiving electrical energy, said electromagnet positioned in the vicinity of said permanent magnet;
d. a switch for controlling the flow of said electrical energy to said electromagnet.

13. The system of claim 4 which additionally comprises a solar collector having an electrical output, said electrical output being connected to dais battery to charge said battery.

14. The system of claim 1 in which said output of said first and second electrical generators are linked to a fluorescent lamp to illuminate said fluorescent lamp.

15. The system of claim 7 in which said first, second, third and fourth generators are linked to a fluorescent lamp to illuminate said fluorescent lamp.

16. A system for generating electrical power comprising
a. a stepper motor having an activating shaft;
b. means for turning said activating shaft to produce an electrical output.

17. The system of claim 16 in which said means for turning said activating shaft comprises a fluid turbine.

18. The system of claim 16 in which said means for turning said activating shaft comprises a wheel.
